(19) United States
(12) Patent Application Publication
(10) Pub. No.: US 2015/0300959 A1
(43) Pub. Date: Oct. 22, 2015

(54) Pulley lagging laminate having a visual wear indicator

(71) Applicants: Danny L. Smith, Daniels, WV (US); Harold C. Seger, Morgantown, WV (US)

(72) Inventors: Danny L. Smith, Daniels, WV (US); Harold C. Seger, Morgantown, WV (US)

(21) Appl. No.: 14/120,044

(22) Filed: Apr. 18, 2014

(51) Int. Cl. G01N 21/88; F16H 55/38; F16H 57/01; B32B 25/16

(52) U.S. Cl. CPC G01N 21/88; B32B 25/16; F16H 55/38; F16H 57/01; B32B 2307/416; B32B 2307/3065; B32B 2433/00; F16H 2057/014

(57) ABSTRACT

A pulley lagging laminate with at least one inner layer having different light reflecting embodiments than the outer layer. When the outer layer wear reaches the inner layer(s), the different reflecting embodiments of the inner layer(s) signal the need to replace the worn lagging laminate.

### BACKGROUND

1. Field of Invention

This invention relates to a method of making a pulley lagging laminate which provides an indication of lagging wear.

2. Discussion of Prior Art

Drive pulleys such as used with coal mine conveyor belts frequently have a lagging on their surface to reduce conveyor belt slippage. This lagging is usually a black rubber.

After time in service, the rubber lagging compound on these pulleys becomes worn and must be replaced. If conveyor belt operation continues after the lagging is completely worn out, the metal pulley surface will be damaged and the pulley will have to be repaired or even may have to be scrapped. Mine operators visually inspect the lagging in an attempt to determine the approximate depth of lagging wear. To be done thoroughly and safely, the conveyor belt must be shut for this visual inspection.

One disadvantage of all present lagging compounds is that there is no way to determine when the wear of the lagging is down to the specific point where the lagging must be replaced. If the lagging wears out and is not replaced, the pulley drum will be damaged and repairs will be costly.

### Objects and Advantages

Accordingly, several objects and advantages of our method which has all of the advantages of the prior art and none of the disadvantages are:
(a) to provide a visual signal when the lagging laminate outer surface has worn down from contact with the underside of the conveyor belt such that the lagging laminate must be replaced.
(b) to provide a visual signal when the lagging laminate outer surface has worn down to a pre-determined level so that advance planning for replacement of the lagging may be done.
(c) to provide a visual signal of the need for lagging replacement which is easy for the conveyor belt operator to see in the darkened conditions of mining operations.
(d) to provide a visual signal when the lagging laminate outer surface has worn down while the conveyor belt is running. This allows scheduling maintenance shutdown to replace the worn pulley lagging on a routine basis where all the parts and equipment and manpower are available.

Further objects and advantages of our method will become apparent from a consideration of the drawings and ensuing description.

### DRAWING FIGURES

FIG. 1 is a perspective view of a seamless hot vulcanized lagging laminate of the present invention with single outer and inner layers.

FIG. 2 is a perspective view of a seamless hot vulcanized lagging laminate of the present invention with an inner layer sandwiched between outer layers.

### REFERENCE NUMERALS IN DRAWINGS

3. Outer layer
4. Inner layer

### SUMMARY OF THE INVENTION

The present invention relates to a method of making a lagging laminate containing at least one inner layer of material with different light reflectance than the outer layer or layers. The inner layer(s) may be a different color than the outer layer, different material, reflective, fluorescent, phosphorescent, or a combination of these different reflective components. This inner layer of material with different light reflectance will provide a visual, safe, and non-shutdown method of determining the rubber wear on a pulley lagging.

### DESCRIPTION

### Main Embodiment

Before explaining at least one embodiment of the invention in detail, it is to be understood that the invention is not limited in its application to the details of construction and to the arrangements of the components set forth in the following description or illustrated in the drawings. The following is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

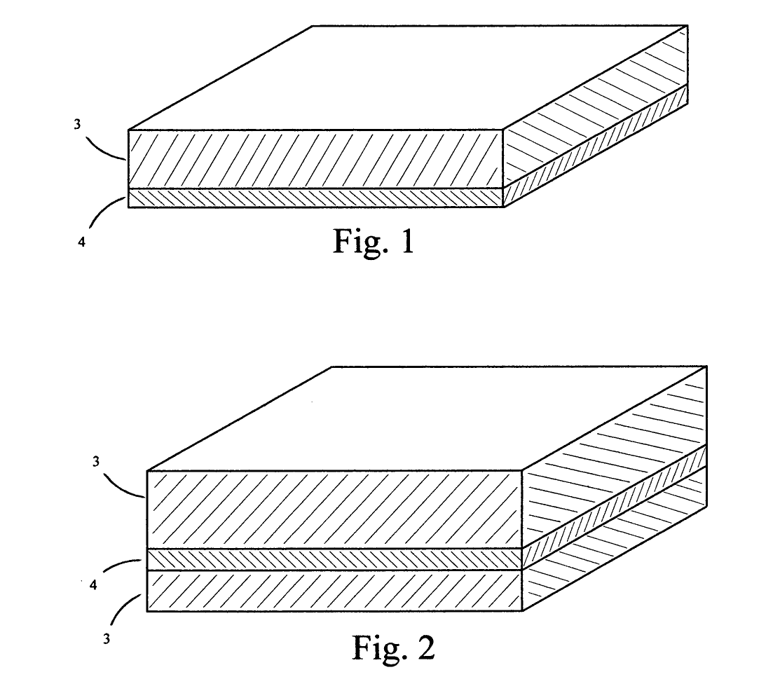

FIG. 1 shows a typical embodiment of our method of constructing a laminate lagging with a inner layer 4 having different light reflectance than a outer layer 3. In this embodiment there is at least one inner layer 4 and it (or they) are a different color than outer layer 3. Outer layer 3 is in contact with the wearing body. Inner layer 4 may contact the pulley surface, or inner layer 4 may be sandwiched between outer layers 3 as in FIG. 2. Inner layer 4 may cover the entire surface of outer layer 3, or inner layer 4 be applied as strips, spots of any geometric design, or a netting covering less than all of outer layer 3. Inner layer 4 is hot vulcanized to outer layer or layers 3 with the aide of a solvent between inner and outer layers, as is well-known in the art.

For outer layer 3, preferably black 60 Shore A Durometer flame-retardant styrene butadiene rubber (SBR) is applied approximately 12 mm thick. Many compound, hardness and color variations exist for outer layer 3. Common rubber options include Chloroprene (neoprene), Natural, Butadiene Acrylonitrile (nitrile), and Ethylene Propylene (EPDM). Hardness ranges from 45-85 shore A Durometer. Color is optional and is usually black. The thickness of outer layer 3 rubber can range from 2 mm to 50 mm.

A rubber solvent, such as Xylene sold by Brenntag Mid-South in the U.S., is usually applied by brush, wiper or roller in less than a 1 mm coat to the surfaces between outer layer 3 and inner layer 4 which will be in contact during vulcanization.

For outer layer 3 and inner layer 4, Table 1 lists the ingredients and the amounts mixed to form the laminate of the present embodiment. Columns 1 and 3 of Table 1 show the chemical or trade names of the ingredient, and columns 2 and 4 list the amounts used in parts per hundred units (pphr) by weight for the present embodiment of the invention. The thickness of inner layer 4 will be approximately 3 mm, but can be between 0.8 mm to 50 mm.

TABLE 1

| Layer 3 Black Rubber | pphr | Layer 4 White Rubber | pphr | Manuacturer |
|---|---|---|---|---|
| styrene-butadiene 1502 rubber | 60 | styrene-butadiene 1502 rubber | 60 | Goodyear |
| polybutadiene rubber | 40 | polybutadiene rubber | 40 | Goodyear |
| stearic acid | 2 to 5 | stearic acid | 2 to 5 | Harwick |
| zinc oxide | 5 to 10 | zinc oxide | 5 to 10 | Akrochem |
| carbon black | 100 | | | Cabot |
| | | Hisil silica dioxide | 40 | Akrochem |
| | | calcium carbonate | 75 | Harwick |
| Sundex process oil | 20 | Sundex process oil | 40 | Sun Oil |
| Wingtak 95 tackifier | 5 | Wingtak 95 tackifier | 7 | Goodyear |
| Cyrstex sulfur | 2.75 | Cyrstex sulfur | 3 | Harwick |
| Altax accelerator | 1 | Altax accelerator | 1.25 | Harwick |
| Unads ultra accelerator | 0.2 | Unads ultra accelerator | 0.4 | R T Vanderbuilt |
| Plastogen homogenizer | 3 | Plastogen homogenizer | 5 | Harwick |
| | | white contrasting color | 10 | Harwick |

It is understood that the preceding description is given merely by way of illustration and not in limitation of the invention and that various modifications may be made thereto without departing from the spirit of the invention as claimed. From the description above, a number of advantages of our method for constructing a pulley lagging laminate having at least one inner layer with different light reflectance than the outer layer become evident.

### OPERATION

### Main Embodiment

FIG. 1 shows a typical embodiment of our method of constructing a laminate lagging with a inner layer 4 having different light reflectance than a outer layer 3. In this embodiment there is at least one inner layer 4 and it (or they) are a different color than outer layer 3. Outer layer 3 is in contact with the wearing body. Inner layer 4 may contact the pulley surface, or inner layer 4 may be sandwiched between outer layers 3 as in FIG. 2. Inner layer 4 may cover the entire surface of outer layer 3, or inner layer 4 be applied as strips, spots, or netting covering less than all of outer layer 3. Inner layer 4 is hot vulcanized to outer layer or layers 3 using a solvent between inner and outer layers as is well-known in the art.

For outer layer 3, preferably black 60 Shore A Durometer flame retardant styrene butadiene rubber (SBR) is applied approximately 12 mm thick, but can be between 2 mm to 50 mm thick. Many compound, hardness and color variations exist for outer layer 3. Common rubber options include Chloroprene (neoprene), Natural, Butadiene Acrylonitrile (nitrile), and Ethylene Propylene (EPDM). Hardness ranges from 45-85 shore A Durometer. Color is optional and is usually black. The typical method of vulcanizing this rubber uses a sulfur cure system.

A rubber solvent, such as Xylene sold by Brenntag Mid-South in the U.S., is usually applied by brush, wiper or roller in less than a 1 mm coat to the surfaces between outer layer 3 and inner layer 4 which will be in contact during vulcanization.

Inner layer 4 and outer layer 3 components can be separately mixed using rubber processing techniques known to those skilled in the art and using standard rubber processing equipment. For example, a wide variety of machines and methods can be used to mix the ingredients, such as open mills, internal mixers, etc. Thickness of inner layer 4 will be approximately 3 mm, but can be between 0.8 mm to 50 mm. The contrasting color layer 4 must have a rubber composition that is compatible with the rubber in layer 3. Further, layer 4 must have a cure system that is the same or similar in composition to the cure system used in the rubber layer 3. If either the rubber composition or the cure systems are not matched correctly, the contrasting color layer 4 could separate from layer 3. Table 1 shows an example of a layer 4 white rubber compound for use with a layer 3 black rubber compound. Columns 1 and 3 of Table 1 show the chemical or trade names of the ingredient, and columns 2 and 4 list the amounts used in parts per hundred units (pphr) by weight for the present embodiment of the invention.

The following components for layers 3 and 4 will be separately thoroughly mixed:

TABLE 1

| Layer 3 Black Rubber | pphr | Layer 4 White Rubber | pphr | Manuacturer |
|---|---|---|---|---|
| styrene-butadiene 1502 rubber | 60 | styrene-butadiene 1502 rubber | 60 | Goodyear |
| polybutadiene rubber | 40 | polybutadiene rubber | 40 | Goodyear |
| stearic acid | 2 to 5 | stearic acid | 2 to 5 | Harwick |
| zinc oxide | 5 to 10 | zinc oxide | 5 to10 | Akrochem |
| carbon black | 100 | | | Cabot |
| | | Hisil silica dioxide | 40 | Akrochem |
| | | calcium carbonate | 75 | Harwick |
| Sundex process oil | 20 | Sundex process oil | 40 | Sun Oil |
| Wingtak 95 tackifier | 5 | Wingtak 95 tackifier | 7 | Goodyear |
| Cyrstex sulfur | 2.75 | Cyrstex sulfur | 3 | Harwick |
| Altax accelerator | 1 | Altax accelerator | 1.25 | Harwick |
| Unads ultra accelerator | 0.2 | Unads ultra accelerator | 0.4 | R T Vanderbuilt |
| Plastogen homogenizer | 3 | Plastogen homogenizer | 5 | Harwick |
| | | white contrasting color | 10 | Harwick |

It will be apparent to one skilled in the arts when the separate mixing of inner layer 4 and outer layer 3 components is complete.

A rubber solvent, such as Xylene sold by Brenntag Mid-South in the U.S., is usually applied by brush, wiper or roller in less than a 1 mm coat to the surfaces between outer layer 3 and inner layer 4 which will be in contact during vulcanization.

After applying the solvent, outer layer 3 and inner layer(s) 4 are placed together to be vulcanized. A wide variety of machines and methods can be used to vulcanize the lagging laminate, including but not limited to, a double band press, a rotary curing press (e.g., rotocure), a autoclave, etc. Curing pressure of approximately 50 psi and cure times sufficient to reach internal lagging temperatures of approximately 260 degrees F. will complete the vulcanization of layers 3 and 4 into a lagging laminate.

### DESCRIPTION AND OPERATION

### Alternative Embodiments

In a second embodiment of the lagging laminate, the differing light reflectance of layer 4 is achieved by using materials in layer 4 which make the layer florescent. This list of materials for the laminate with preferred florescent layer 4 is shown in table 2. Columns 1 and 3 of Table 2 show the chemical or trade names of the ingredient, and columns 2 and 4 list the amounts used in parts per hundred units (pphr) by weight for the present embodiment of the invention.

TABLE 2

| Layer 3 Black Rubber | pphr | Layer 4 Florescent Rubber | pphr | Manuacturer |
|---|---|---|---|---|
| styrene-butadiene 1502 rubber | 60 | styrene-butadiene 1502 rubber | 60 | Goodyear |
| polybutadiene rubber | 40 | polybutadiene rubber | 40 | Goodyear |
| stearic acid | 2 to 5 | stearic acid | 2 to 5 | Harwick |
| zinc oxide | 5 to 10 | | | Akrochem |
| | | magnesium oxide-ultra fine | 5 to 25 | Martin Marietta |
| carbon black | 100 | | | Cabot |
| | | Hisil silica dioxide | 1 to 40 | Akrochem |
| | | Sachtolith zinc sulfide | 5 to 300 | Sachtleben |
| Sundex process oil | 20 | Sun Oil | | |
| | | Clear process oil-USP min. oil | 40 to 100 | American Oils |
| Wingtak 95 tackifier | 5 | | | Goodyear |
| | | Kristalex clear tackifier | 7 to 35 | Eastman Chem. |
| Cyrstex sulfur | 2.75 | Cyrstex sulfur | 3 | Harwick |
| Altax accelerator | 1 | Altax accelerator | 1.25 | Harwick |
| Unads ultra accelerator | 0.2 | Unads ultra accelerator | 0.4 | R T Vanderbuilt |
| Plastogen homogenizer | 3 | | | Harwick |
| | | Plastogen clear homogenizer | 5 | Harwick |
| | | UV brightener | 1 to 50 | Mayzo |
| | | UV powder sku V01-ORE | 1 to 50 | Techno Glow |

In a third embodiment of the lagging laminate, the differing light reflectance of layer 4 is achieved by using materials in layer 4 which make the layer phosphorescent. Standard sulfur cure systems for rubber do not work for this embodiment because they will nullify the phosphorescence. Further, the polymers used must be clear in nature. As most polymers range in the milky to blown color range, their use will also nullify the desired visual enhancements.

Thus, two areas must be addressed. This invention covers a cure system change for the rubber compound in layers 3 and 4 from a “sulfur cure system” to a “peroxide cure system” for the third embodiment. Also, our invention uses clear polymers like certain polyurethanes, ethylene vinyl acetate, clear pale crepes, polybutadiene, and others cured with a “peroxide cure system” in layer 4.

This list of materials for the laminate with a black rubber layer 3 and a phosphorescent layer 4 is shown in table 3. Columns 1 and 3 of Table 3 show the chemical or trade names of the ingredient, and columns 2 and 4 list the amounts used in parts per hundred units (pphr) by weight for the present embodiment of the invention.

TABLE 3

| | | Layer 4 Phosphorescent | | |
|---|---|---|---|---|
| Layer 3 Black Rubber | pphr | Rubber | pphr | Manuacturer |
| styrene-butadiene 1502 | 60 | clear polymer (polybutadiene | 100 | Goodyear |
| rubber | | eg.) | | |
| polybutadiene rubber | 40 | UV powder sku V01-ORE | 1 to 50 | Techno Glow |
| stearic acid | 2 to 5 | | | Hawick |
| zinc oxide | 5 to 10 | | | Akrochem |
| carbon black | 100 | | | Cabot |
| | | Cab-o-Sil fumed silica | 5 to 40 | Cabot |
| | | Kristalex clear tackifiers | 0 to 75 | Eastman Chem. |
| Sundex process oil | 20 | | | Sun Oil |
| | | Clear process oil-USP min. | 0 to 50 | American Oils |
| | | oil | | |
| Wingtak 95 tackifier | 5 | | | Goodyear |
| | | Saret 515 acrylic co-agent | 0 to 45 | Sartomer |
| Saret 515 acrylic co-agent | 1 to 35 | | | Sartomer |
| | | Ricon 153 rubber co-agent | 0 to 25 | Cray Valley Chem. |
| Zinc diacraylate | 0 to 50 | Zinc diacraylate | 0 to 35 | Sartomer |
| Vulcup 40 KE peroxide | 0.1 to 15 | Vulcup 40 KE peroxide | 0.1 to 15 | Harwick |
| Plastogen homogenizer | 3 to 15 | | | Harwick |
| | | Plastogen clear homogenizer | 0 to 5 | Harwick |
| Perkodox 40E peroxide 2 | 0.1 to 10 | Perkodox 40E peroxide 2 | 0.1 to 10 | AkzoNobel Chem. |

In a forth embodiment of the lagging laminate, the differing light reflectance of layer 4 is achieved by using materials in layer 4 which make the layer “sparkle” as they reflect much of the incident light directed at it. This list of materials for a laminate with a “sparkling” incident light reflecting layer 4 is shown in table 4. Columns 1 and 3 of Table 4 show the chemical or trade names of the ingredient, and columns 2 and 4 list the amounts used in parts per hundred units (pphr) by weight for the present embodiment of the invention.

TABLE 4

| Layer 3 Black Rubber | pphr | Layer 4 “Sparkle” Rubber | pphr | Manuacturer |
|---|---|---|---|---|
| styrene-butadiene 1502 | 60 | Clear polymer | 100 | Goodyear |
| rubber | | (polybutadiene eg.) | | |
| polybutadiene rubber | 40 | UV powder sku V01-ORE | 1 to 50 | Techno Glow |
| stearic acid | 2 to 5 | | | Harwick |
| zinc oxide | 5 to 10 | | | Harwick |
| carbon black | 100 | “Sparkle” pigment (s) | 0 to 400 | Cole Palmer |
| | | Cab-o-Sil fumed silica | 5 to 40 | Cabot |
| | | Kristalex clear tackifiers | 0 to 75 | Eastman Chem. |
| Sundex process oil | 20 | | | Sun Oil |
| | | Clear process oil-USP min. | 0 to 50 | American Oils |
| | | oil | | |
| Wingtak 95 tackifier | 5 | | | Goodyear |
| | | Saret 515 acrylic co-agent | 10 to 45 | Sartomer |
| Saret 515 acrylic co-agent | 1 to 35 | | | Sartomer |
| | | Rican 153 rubber co-agent | 20 to 25 | Cray Valley Chem. |
| Zinc diacraylate | 0 to 50 | Zinc diacraylate | 0 to 35 | Sartomer |
| Vulcup 40 KE peroxide | 0.1 to 15 | Vulcup 40 KE peroxide | 0.1 to 15 | Harwick |
| Plastogen homogenizer | 3 to 15 | | | Harwick |
| | | Plastogen clear homogenizer | 0 to 5 | Harwick |
| Perkodox 40E peroxide 2 | 0.1 to 10 | Perkodox 40E peroxide 2 | 0.1 to 10 | AkzoNobel Chem. |

While the present inventions have been described in conjunction with various embodiments and examples, it is not intended that the present inventions be limited to such embodiments or examples. On the contrary, the present inventions encompass various alternatives, modifications, and equivalents, as will be appreciated by those of skill in the art.

While the inventions have been particularly shown and described with reference to specific illustrative embodiments, it should be understood that various changes in form and detail can be made without departing from the spirit and scope of the present inventions. Therefore, all embodiments that come within the scope and spirit of the present inventions, and equivalents thereto, are claimed.

### CONCLUSION, RAMIFICATIONS AND SCOPE

The present inventions pertain to lagging laminates, and in particular, to lagging laminates that contain layers of different light reflectance such that the level of laminate wear can be shown by the different reflectance of an inner layer. Various embodiments of the present inventions can be used, for example, in the mining, cement, concrete and aggregate sectors in applications where determining the level of wear of rubber parts is critical. Examples of possible applications, include, but are not limited to, use as a lining material to protect surfaces handling abrasive material such as for chutes, hoppers, cyclones, pipes, elbows, tanks, collectors, truck bins, silos, vibrators, etc.; use on conveyor belt skirting and scrapers; use on pulley lagging; use on sand blasting curtains; etc., and in general on any application that involves wear of a rubber material.

Although the descriptions above contain many specifics, these should not be construed as limiting the scope of the invention but as merely providing illustrations of some of the presently preferred embodiments of this invention. Many other variations are possible. Other combinations of outer and inner layers are possible. Other thickness and shapes of outer and inner layers are possible. Other materials to achieve differing light reflectance are possible. Thus the scope of our invention should be determined by the appended claims and their legal equivalents, rather than by the examples given.

We claim:

1. A pulley lagging laminate comprising: a opaque-colored outer layer or plurality of outer layers and a opaque-colored inner layer or plurality of opaque-colored inner layers, wherein the improvement comprises said inner layer or inner layers which have different light reflectance than said outer layer or outer layers and abrasion of said outer layer reveals the different light reflectance of said inner layer or inner layers whereby a visual wear indicator for the pulley lagging laminate is provided.

2. The pulley lagging laminate according to claim 1 wherein said outer layer or outer layers are essentially flame retardant thermosetting rubber.

3. The pulley lagging laminate according to claim 1 wherein said inner layer or inner layers are a different color than said outer layer or outer layers.

4. The pulley lagging laminate according to claim 1 wherein said inner layer or inner layers comprises florescent, phosphorescent, or reflective “sparkle” materials.

5. The pulley lagging laminate according to claim 1 wherein said outer layer or outer layers and said inner layer or inner layers for the phosphorescent light reflecting embodiment are peroxide cured and chemically bonded to each other by vulcanization.

6. The pulley lagging laminate according to claim 1 wherein said outer layer or outer layers are a continuous, extruded, milled or calendared layer or layers.

7. The pulley lagging laminate according to claim 1 wherein said inner layer or inner layers are a extruded, milled, molded or calendared continuous or discontinuous layer or layers.

8. A method of detecting pulley lagging wear comprising the steps of providing a pulley lagging laminate having at least one outer layer of one light reflectance, and at least one inner layer of a different light reflectance, and abrading said outer layer to reveal the light reflectance of said inner layer.

9. The method according to claim 8 wherein observing the light reflectance of said inner layer indicates wear-through of said outer layer.

10. The method according to claim 8 wherein observing the light reflectance of said inner layer is an early warning system for detecting wear-through of said outer layer.
